(19) United States
(12) Patent Application Publication
(10) Pub. No.: US 2012/0276832 A1
(43) Pub. Date: Nov. 1, 2012

(54) Air Curtain, And A Vehicle Provided With Such An Air Curtain

(75) Inventors: Peter Quaak, Utrecht (NL); Joannes Jozef Gerardus Opdam, Amsterdam (NL)

(73) Assignee: H. OPDAM MANAGEMENT B.V., BW Amsterdam (NL)

(21) Appl. No.: 13/458,411

(22) Filed: Apr. 27, 2012

(30) Foreign Application Priority Data
Apr. 29, 2011 (NL) 1038785

(51) Int. Cl. B60J 9/04; B60P 3/20

(52) U.S. Cl. 454/91; 454/104; 454/188

(57) ABSTRACT

The present invention relates to an air curtain comprising a longitudinally extending frame comprising
a longitudinally extending air inlet opening; and
a longitudinally extending air outlet.

According to the invention there is a row of electrical fans between the longitudinally extending air outlet and the longitudinally extending air inlet opening for introducing air into the air curtain and expelling it through the longitudinally extending, downward facing air outlet for generating an air-curtain. The invention also relates to a vehicle provided with such an air curtain.

The present invention relates to an air curtain comprising a longitudinally extending frame comprising
a longitudinally extending air inlet opening; and
a longitudinally extending air outlet.

It is well-known to use a vehicle, such as a truck or a trailer to transport freight that has to be kept cool, or even frozen. It is also possible that the cargo has to be kept at a higher temperature than the ambient temperature, e.g. above freezing point in cold climates. It is known in the art to provide such vehicles with an air curtain, which is a device for providing a downward flow of air near the access opening of a cargo space so as to reduce the ingress of ambient air when the cargo door is open. Thus a significant saving in energy can be achieved. In case of perishable freight, the air curtain may prevent perishing, avoiding significant financial loss. The downward flow of air generated by an air curtain is also called an air curtain. To avoid ambiguity, in the present application the flow of air will be written with a hyphen as air-curtain. The better the air curtain works, i.e. longer the distance over which there is a (laminar) downward flow of air towards the floor and preferably to the floor of the cargo space, the more it helps to ensure that the cargo remains at the desired temperature and energy for cooling (or perhaps heating) is saved by reducing the ingress of ambient air. It goes without saying that the energy consumption of the air curtain should be relatively modest.

The problem with an air curtain is that to provide an even, downward flow of air an air outlet is required that extends over a relatively long distance downwardly. In the cargo space of a vehicle, such a relatively high air curtain would hinder stacking and/or loading. Also, being positioned near the entrance of the cargo space, the air curtain is susceptible to damage, for example by a fork-lift truck.

The object of the present invention is to provide an air curtain for a vehicle that allows for a relatively low height of the air curtain.

To this end, an air curtain according to the preamble is characterized in that there is a row of electrical fans between the longitudianally extending air outlet and the longitudinally extending air inlet opening for introducing air into the air curtain and expelling it through the longitudinally extending air outlet for generating an air-curtain.

A row of electrical fans distributed over the length of the longitudinally extending air outlet allows for a homogenous air speed distribution along the length of the longitudinally extending air outlet. In general, the air curtain will comprise a housing so as to define an air chamber between a longitudinally extending air inlet opening and a longitudinally extending air outlet. The housing may constitute the frame, or part thereof. The electrical fans will be fans that are customarily used in computers. The dimensions of such computer fans are small, reducing the height of the air curtain. A typical height of suitable fans is 9 cm or less, this height including the housing of the fan, if any.

According to a preferred embodiment, there are at least 6 electrical fans per meter of the longitudinally extending air outlet and preferably at least 8.

This allows for a homogenous air speed distribution along the length of the longitudinally extending air outlet. In practice, the number of electrical fans will be 10 or more per m.

According to a preferred embodiment, the electrical fans have a spacing of less than 5 cm, preferably less than 3 cm between each other, and more preferably less than 1 cm.

This results in a very homogenous air-curtain extending over a long distance. It is most preferred that the electrical fans are immediately adjacent to each other.

According to a preferred embodiment, the plane of rotation of the electrical fans is at an angle to the direction of the flow path defined by the air outlet.

This reduces the height taken up by the air curtain. The angle (in a plane perpendicular to both the plane of the air-curtain produced by the air curtain and the longitudinal direction of the row of electrical fans) will be less than 60°, such as between 30° and 60°.

According to a preferred embodiment, an air diffuser is provided between the electrical fans and the longitudinally extending air outlet.

This results in a more homogenous air-curtain extending over a long distance from the longitudinally extending air outlet. The air diffuser is for example a metal grid.

According to a preferred embodiment, downstream of an electrical fan there is an air diffuser having i) an central inlet opening downstream of the center of the electrical fan and ii) a central outlet opening, the ratio of the surface area of the central inlet opening to the surface area of the central outlet opening>1.1, defining a convergent flow path, and a second flow path downstream of the electrical fan bypassing said convergent flow path and merging with the convergent flow path before the longitudinally extending air outlet.

An electrical fan produces an air stream which is resembles a hollow cylinder of moving air. By having provided a diffuser with a central inlet opening capable of collecting part of the moving air, like the inner cylindrical section of the hollow cylinder, the remaining air will pass around the central inlet opening and slows down in a diverging path because the surface area of the central outlet opening is smaller. Similarly, the air passed through the central inlet opening will be sped up because it passes the air diffuser via a convergent path. For optimum results, the diffuser will be designed such that both air speeds are substantially the same downstream of the air diffuser. The central opening of the diffuser may be a single opening for more than one electrical fan, in which case the air from the electrical fans will flow in part above and below the diffuser and for the remaining part through the central opening.

According to a preferred embodiment, the air curtain comprises curved baffles for guiding air from a first direction determined by at least one of the electrical fan and a housing of the air curtain to a second direction defined by at least one of the housing of the air curtain and the outlet opening of the air curtain.

Such baffles will help to combat turbulence and help to maintain laminar flow in bends of the flow path of air through the air curtain. It has been found that such baffles may reduce the power consumption by the electrical fans significantly (in one instance by over 10%) which is very important for operating the air curtain on the battery of a vehicle such as a truck when the engine is not running to avoid local air polution.

Finally, the present invention relates to vehicle comprising an air curtain, wherein the air curtain is an air curtain as disclosed above.

The present invention will now be illustrated with reference to the drawing where

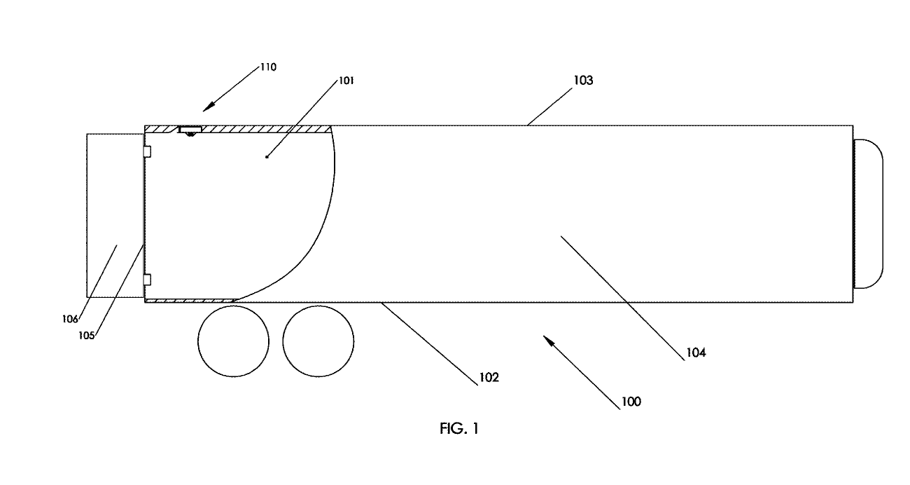

FIG. 1 shows a side view of a vehicle with a cargo space, the cargo space being in a partial cut-out view;

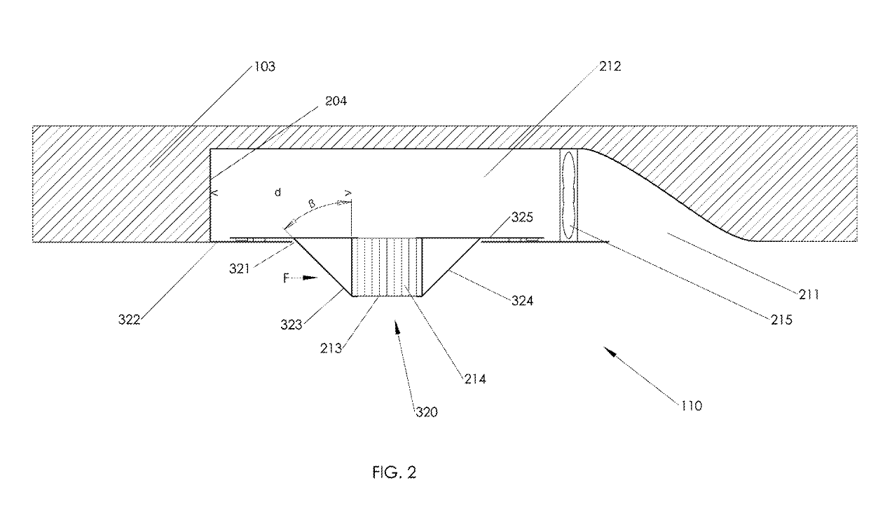

FIG. 2 shows an air curtain visible in FIG. 1 in detail;

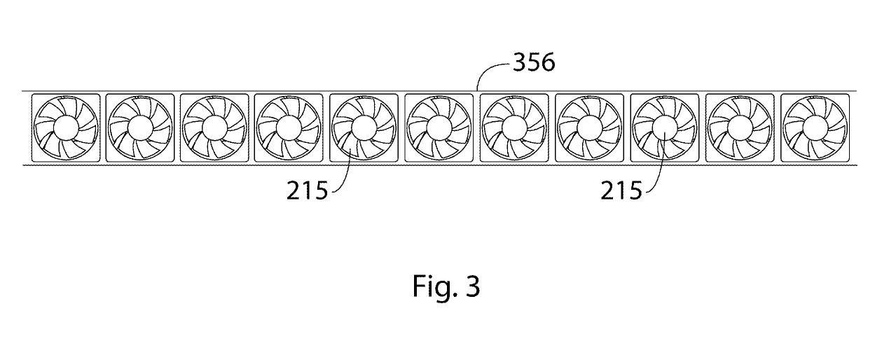

FIG. 3 shows a front view of a row of fans of the air curtain of FIG. 2;

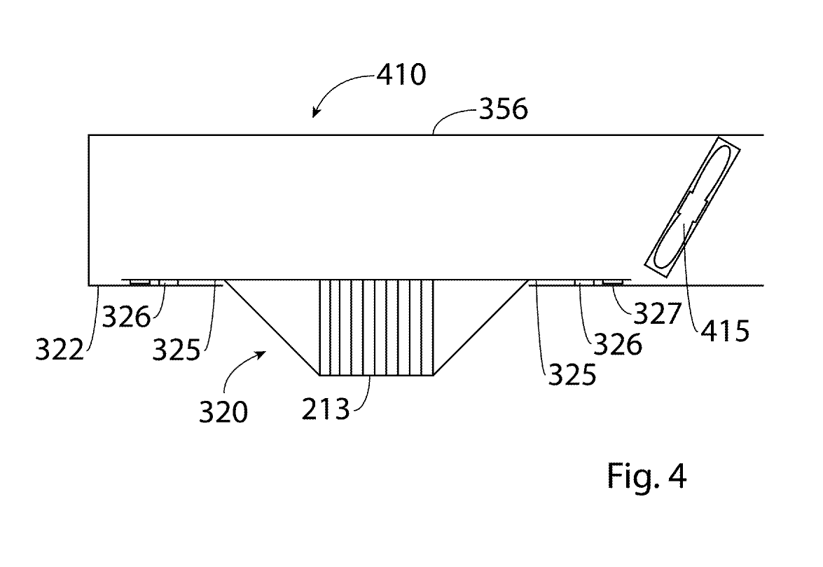

FIG. 4 shows a cross-sectional view of an alternative air curtain with tilted fans;

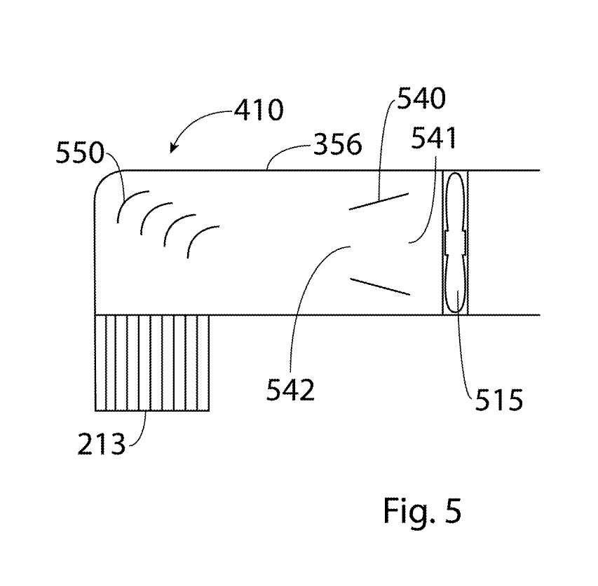

FIG. 5 shows a cross-sectional view of an alternative air curtain with a diffuser;

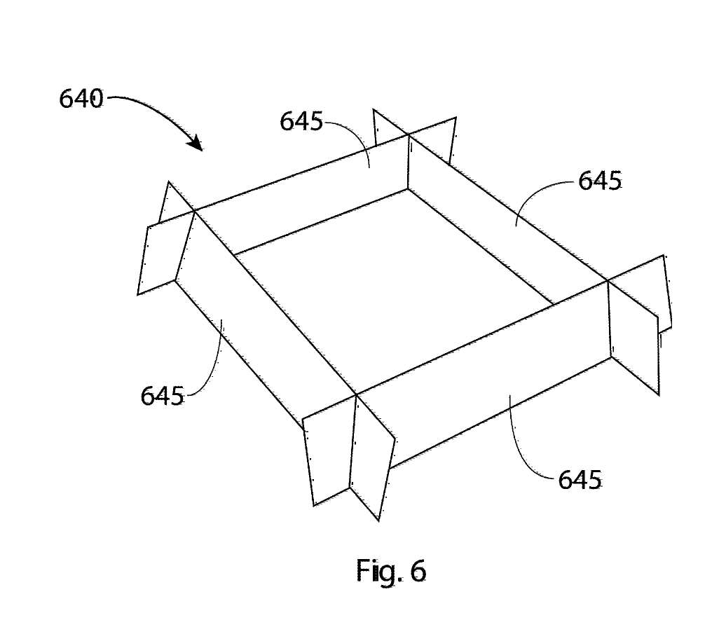

FIG. 6 shows a perspective view of the diffuser of FIG. 5; and

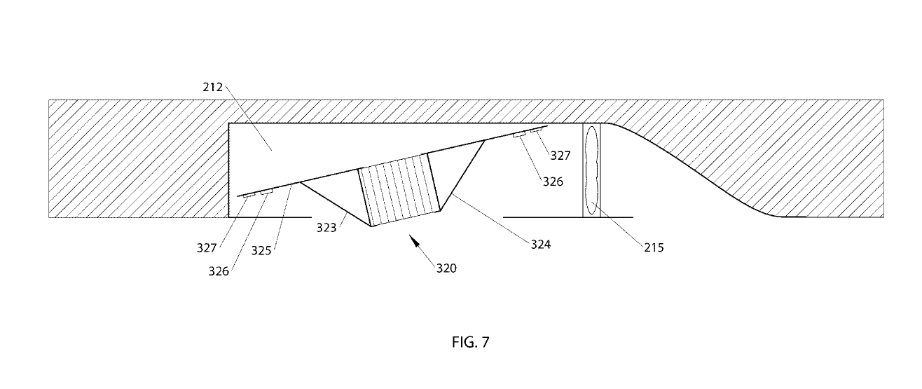

FIG. 7 shows the air curtain of FIG. 2, a unit having air outlet channels being tilted.

FIG. 1 shows a vehicle, in particular a trailer 100 with a cargo space 101 defined by a floor 102, a ceiling 103, and (four) sidewalls 104. One of the sidewalls (in this case as is usual the wall at the back of the vehicle) is provided with an access opening 105 that can be closed with a cargo door 106. As such, the vehicle is as common as it gets. However, the trailer 100 is provided with an air curtain 110. This air curtain 110 extends over the entire width of the cargo space 101 so as to provide an air-curtain over the width and height of the cargo space 101.

Now reference is made to FIG. 2, a mirror image of a detail of FIG. 1. The ceiling 103 is an insulated ceiling comprising polystyrene foam having a thickness of 10 cm. Part of this foam has been removed to make room for an air curtain 110 comprising an inlet opening 211 facing the access opening 105, an air chamber 212 and an outlet opening 213 (the reference line of 213 ends at the distal end of the unit 320 discussed below). The outlet opening 213 comprises a multitude of parallel tubes (defining straight channels with a path length of 5 cm) 214, the centerlines of said tubes 214 being perpendicular to the floor 102. A row of computer fans 215 extending over the length of the air curtain 110 (and hence over the width of the cargo space 101) draw in ambient air via the inlet opening 211, introducing it into the air chamber 212 from which it flows through the parallel tubes 214 out of the outlet opening 213, creating in effect a vertical air-curtain.

To improve the quality of the air-curtain, the volume of the air chamber is increased by the distance d from a back wall 204 of the air curtain 110 being spaced horizontally by at least 2 cm from the outlet opening 213.

The parallel tubes 214 are part of a unit 320 that in use (and as shown in FIG. 2) is seated in an opening 321 of the bottom 322 of the air curtain 110. The unit 320 has two bevelled sides 323, 324, that allow the unit 320 to be taken up inside the air chamber 212 if a force (arrow F) is exerted inadvertently on the unit 320, e.g. if a pallet loaded with parcels is moved out of the cargo space 101. It will return to its proper position for generating an air-curtain once the pallet is removed from the cargo space 101. This set-up also allows the cargo space 101 to be filled with cargo against the ceiling 103, without the air curtain 110 being in the way.

FIG. 3 shows a partial rear-view of the air curtain 110 of FIG. 2. The fans 215 are positioned as a row of fans 215 in housing 356 of the air curtain 110. The housing 356 serves as a frame for the air curtain 110.

FIG. 4 shows an air curtain 410 which basically corresponds to air curtain 110, except that the fans 415 are in a tilted position. In the embodiment shown, the air curtain 410 has flanges 325 that in the seated position will rest on the bottom 322 of the air curtain. To avoid noise from the unit 320 due to vibrations of the trailer 100 while moving, rubber pads 326 may be provided which should provide a seal so as to avoid air from leaking out of the air chamber 212. Also, magnets 327 may be used to keep the unit 320 seated.

FIG. 5 shows a cross-sectional view of an alternative air curtain 410 comprising a housing 356, an electrical fan 515 and an outlet opening 213 comprising a multitude of parallel tubes (defining straight channels with a path length of 5 cm) 214.

The air curtain 410 comprises a diffuser 540 comprising a central inlet opening 541 and a central outlet opening 542. The surface area of the former is larger than that of the latter. This helps to speed up the air entering the central inlet opening 541.

Air passing between the diffuser 540 and the housing 356 (second flow path that bypasses the flow path between the central inlet opening 541 and a central outlet opening 542) is slowed down, because the upstream surface area provided by the diffuser 540 outside the central inlet opening 541 is smaller than the surface area left by the central outlet opening 541. This slows air passing around the central outlet opening 541 down.

To smoothly guide the air from the diffuser 540, consisting of two elongated strips extending over the width of the air curtain, to the outlet opening 213, curved baffles 550 are provided. Dimensioning of the central inlet opening 541 and a central outlet opening 542 is preferably done such that the speed of the air leaving the central outlet opening 542 is substantial equal to the speed of air having bypassed the path through the central outlet opening 542, i.e. where the two flow paths meet. This allows for an air curtain having a reduced length.

FIG. 6 shows an alternative diffuser 640 for a single electrical fan, built using 4 rectangular aluminium platelets 645, angled to form a frusto-pyramdal cone. A multitude of such diffusers 640 would be placed inside the air curtain.

The present invention is not limited by the above embodiments and can be varied within the scope of the claims. The row of electrical fans is not necessarily on a straight line, but may for example be placed on a curved line, such as a circle segment. This allows for an increase of the number of electrical fans, and hence an increased air speed from the outlet. For the same reason, the outlet opening will generally be linear. In general, an outlet opening will have a width of at least 2 cm, preferably at least 3 cm such as at least 4 cm.

The present invention relates to a method of providing a vehicle for transporting freight that has to be kept at a temperature different from the ambient temperature of the vehicle with an air curtain, the vehicle comprising a closed cargo space defined by a floor, a ceiling, and upright walls, an upright wall of said upright walls having an access opening that can be closed with a cargo door, the method comprising the step of providing the vehicle at the ceiling with the air curtain, said provided air curtain having
a longitudinally extending air inlet opening;
a longitudinally extending, downward facing air outlet;
an air chamber downstream of the longitudinally extending air inlet opening and upstream of the longitudinally extending, downward facing air outlet.

In the present application, the term “vehicle for transporting freight that has to be kept at a temperature different from the ambient temperature” includes both motorized and non-motorized vehicles, such as a vehicle chosen from a van, a truck, and a trailer. Usually, the vehicle will be used to transport freight that has to be kept cool, or even frozen. However, it is feasible that the cargo has to be kept at a higher temperature than the ambient temperature, e.g. above freezing point in cold climates. It is known in the art to provide vehicles with an air curtain, which is a device for providing a downward flow of air near the access opening so as to reduce the ingress of ambient air when the cargo door is open. Thus a significant saving in energy can be achieved. In case of perishable freight, the air curtain may delay and/or prevent perishing thus avoiding significant financial loss. The downward flow of air generated by an air curtain is also called an air curtain. To avoid ambiguity, in the present application the flow of air will be written with a hyphen as air-curtain. The better the air curtain works, i.e. longer the distance over which there is a (laminar) downward flow of air towards the floor and preferably to the floor of the cargo space, the more it helps to ensure that the cargo remains at the desired temperature and energy for cooling (or perhaps heating) is saved by reducing the ingress of ambient air.

In practice, providing such a proper air-curtain is a challenge. Because cargo space comes at a premium, this imposes limits to the acceptable height of the air curtain, which in turn makes it harder to provide a proper air-curtain, that is an air-curtain that saves at least the desired amount of energy.

The object of the present invention is to provide a vehicle with an air curtain that i) reduces the risk of damaging the air curtain, and/or ii) allows for better usage of the cargo space.

To this end, the invention according to the preamble is characterized in that the vehicle is provided with an air curtain such that the air curtain comprises a unit containing the longitudinally extending air outlet, the unit having a distal end, wherein the unit is mounted such that the distal end of the unit is moveable with a directional component transverse to the ceiling.

In this way, if a piece of cargo hits the unit—for example if the cargo space is loaded to the gills, or in case of a clumsy action by a fork-lift truck driver—the air curtain will not be damaged and/or the cargo space is used to a better extent because space that is occupied by the unit may contain cargo. In accordance with the present invention, the unit is temporarily received by the air chamber and/or the volume of the air chamber is temporarily reduced. The length of the directional component transverse to the ceiling over which the distal end is capable of moving will in general be at least 1 cm, such as at least 2 cm, more preferably at least 3 cm. The unit may or may not be attached to the bottom. If it is not attached to the bottom of the air curtain, it will generally be designed to prevent or reduce the escape of air from the chamber via a route other than the longitudinally extending, downward facing air outlet. The unit may be self-seating under the influence of gravity. Proper seating may be assisted by means of a spring action or the use of magnetism. Thus, once the force causing the unit to move upwards is reduced or eliminated, the unit will resume a position in which it is closer to the floor of the vehicle, where it is best at providing optimum protection against ingress of ambient air. In the seated position, the leakage of air is avoided. The unit may be held in a tensioned elastic bottom, e.g. between two longitudinal rubber sheets, one at each longitudinal side of the unit. The longitudinal rubber sheets may rest on support means such as struts to prevent sagging. In particular for cargo that has to be kept cool, it is preferred that the air inlet opening faces the access opening of the cargo space of the vehicle. Thus ambient air flows downward and a person near the opening is not subjected to an unpleasant stream of cold air. Generally, the ceiling of the vehicle will be provided with the air curtain such that the air curtain is—in a plane parallel to the ceiling—at an angle a with the plane of the access opening of the vehicle of less than 20°. The air outlet will generally comprise one or more straight channels having a path length of at least 2 cm that connect the air chamber with the cargo space. By way of example, the air outlet may comprise at least two parallel walls be defining one or more longitudinally extending air outlets, the parallel walls being capable of partially protruding from said bottom. In the present invention, the term “longitudinally extending” is in reference to the air curtain (not the vehicle). Generally, the air curtain will be provided at a distance of less than 2 m from the access opening. In particular for an air curtain with a rigid bottom, that is a bottom not capable of moving with respect to the longitudinally extending air inlet opening, the distal end of the unit is capable of partially protruding from said bottom.

According to a preferred embodiment, a longitudinally extending side of the unit is beveled so as to allow the distal end of the unit to move towards the ceiling if a force with a directional component parallel to the ceiling is exerted on said beveled, longitudinally extending side of the unit.

Thus, if a piece of cargo is moved horizontally by a fork-lift truck and hits the unit, the unit will move up into the air chamber, avoiding damage to the air curtain. The longitudinally extending side may be chamfered (rounded) or the longitudinally extending side may taper towards the distal end of the unit.

According to a preferred embodiment, the unit of the air curtain that is provided has a longitudinally extending side at an inclined, non-perpendicular angle with the floor at at least one longitudinal side of i) the side facing the access opening, and ii) the side facing away from the access opening.

Thus, if a piece of cargo is moved horizontally by a fork-lift truck and hits the unit, the unit will move up into the air chamber, avoiding damage to the air curtain. The angle with the floor will generally be between 10° and 70°, preferably between 30° and 60° in a vertical plane perpendicular to the longitudinal direction of the air curtain.

According to a preferred embodiment, the ceiling of the vehicle is an insulated ceiling having an upper surface and a lower surface, and the air chamber is provided at least partially above the lower surface of the insulated ceiling.

The insulated ceiling is for example a foam-insulated ceiling. For retrofitting a vehicle with an air curtain, part of the foam may be removed to provide space for mounting the air curtain in an at least partially sunk manner. For newly built vehicles, the ceiling will be designed to have a space for mounting the air curtain. Being at least partially sunk in the insulated ceiling allows more ready access for cargo and for loading/unloading apparatus such as a fork-lift truck.

According to a preferred embodiment, a row of electrical fans between the longitudinally extending air outlet and the longitudinally extending air inlet opening is provided for introducing air into the air curtain and expelling it through the longitudinally extending, downward facing air outlet for generating an air-curtain.

These fans will be fans that are customarily used in computers. This allows for the homogenous supply of air to the air chamber which helps to improve the quality of the air-curtain. The dimensions of such computer fans are small, reducing the height of the air curtain. A typical height of suitable fans is 9 cm or less, this height including the housing of the fan, if any. The electrical fans may be mounted at an angle to the longitudinal direction of the flow path defined by the air outlet. This reduces the height taken up by the air curtain. The electrical fans may be mounted moveable with respect to the ceiling, for example such that the angle may be varied if a force with a directional component parallel with the ceiling is exerted, reducing the chance of damage to the air curtain. The electrical fans are preferably at a horizontal distance of at least 1 cm from the longitudinally extending, downward facing air outlet.

According to a preferred embodiment, the vehicle is provided with an air curtain such that the air chamber comprises a back wall opposite of the longitudinally extending air inlet opening, said back wall being at a horizontal distance of at least 2 cm from the longitudinally extending, downward facing air outlet.

It has been found that an air-curtain created by such an air curtain is more effective, i.e. operates over a longer vertical distance from the air outlet. Thus it is possible to use the air curtain for a vehicle with a larger cargo space height, use the air curtain so as to more effectively protect against the ingress of ambient air, use an air curtain with reduced height with the same protection against the ingress of ambient air, or cut back on the energy required to operate the air curtain. The back wall may be part of the vehicle or the air curtain may comprise a housing, the back wall being a wall of said housing.

According to a preferred embodiment, the air outlet of unit comprises a plurality of tubular through channels.

This results in a more homogenous air-curtain, which allows the height of the air curtain to be reduced. The tubular through channels are generally parallel and straight, at the very least at the distal end of the longitudinally extending outlet opening of the unit.

Finally, the present invention relates to an air curtain comprising a longitudinally extending frame comprising
a longitudinally extending air inlet opening; and
a longitudinally extending air outlet, wherein the air curtain comprises a unit containing the longitudinally extending air outlet, the unit having a distal end that is moveable with respect to the air curtain frame in a plane perpendicular to the longitudinal direction of the longitudinally extending frame.

Such an air curtain having an elongated frame will be mounted such that the air-curtain generated by the air curtain will be in a substantially vertical plane, the air moving downward in the cargo space of a vehicle. In this way, if an object such as a piece of cargo hits the unit—for example if the cargo space is loaded to the gills, or in case of a clumsy action by a fork-lift truck driver—the air curtain will not be damaged. Thus it is possible to use the air curtain of such a design for a vehicle with a larger cargo space height, use the air curtain so as to more effectively protect against the ingress of ambient air, use an air curtain with reduced height with the same protection against the ingress of ambient air, or cut back on the energy required to operate the air curtain. The unit may be designed to be self-seating under the influence of gravity or may be assisted by means of a spring action or the use of a magnet. Thus, once the force causing the unit to move vertically up is reduced or eliminated, the unit will resume a position in which it protrudes further from the frame, where it will be best at providing a proper air-curtain. Generally, the unit will comprise a plurality of tubular through channels. In general, the air curtain will comprise a housing so as to define an air chamber between a longitudinally extending air inlet opening and a longitudinally extending air outlet. The length of the directional component over which the distal end is capable of moving will in general be at least 1 cm, such as at least 2 cm, more preferably at least 3 cm. Any preferred embodiment discussed above for the method is considered a preferred embodiment for the air curtain as such as well. The movement allowed by the unit is for example a tilting movement.

According to a favourable embodiment, the air curtain comprises a unit containing the longitudinally extending air outlet, the unit having a distal end that is moveable with respect to the air curtain with a directional component parallel to a flow path defined by the longitudinally extending air outlet at the distal end thereof.

This allows for the unit to be received at least partially within the air curtain (110), effectively being out of harms way.

According to a preferred embodiment, the air curtain has a bottom and the distal end of the unit is capable of partially protruding from said bottom.

The unit may move relative to the bottom, or may move together with the bottom. More details concerning the bottom have been discussed for the method.

According to a preferred embodiment, a longitudinally extending side of the unit is beveled so as to allow the distal end of the unit to move towards the frame of the air curtain if a force perpendicular to the flow path of the longitudinally extending air outlet at the distal end of the unit is exerted on said longitudinally extending side of the unit.

Thus, if a piece of cargo is moved horizontally by a fork-lift truck and hits the unit, the unit will move towards the frame, avoiding damage to the air curtain. The longitudinally extending side may be chamfered (rounded) or the longitudinally extending side may taper towards the distal end of the unit.

According to a preferred embodiment, a longitudinally extending side of the unit is at an angle β to the direction of the flow path for air defined by the longitudinally extending air outlet at the distal end of the unit, the angle β being in a plane perpendicular to the longitudinal direction of the longitudinally extending air outlet, the angle β being between 20 and 80°.

The angle β will preferably be between 30° and 60° in a vertical plane perpendicular to the longitudinal direction of the air-curtain provided by the air curtain. It is preferred that both the longitudinal sides are at an angle β, although the values for said angle β may differ.

According to a preferred embodiment, there is a row of electrical fans between the longitudinally extending air outlet and the longitudinally extending air inlet opening for introducing air into the air curtain and expelling it through the longitudinally extending, downward facing air outlet for generating an air-curtain.

These fans will be fans that are customarily used in computers. This allows for the homogenous supply of air to the air chamber which helps to improve the quality of the air-curtain. The dimensions of such computer fans are small, reducing the height of the air curtain. A typical height of suitable fans is 9 cm or less, this height including the housing of the fan, if any. The electrical fans may be mounted at an angle to the longitudinal direction of the flow path defined by the air outlet. This reduces the height taken up by the air curtain

According to a preferred embodiment, the electrical fans are mounted tiltable able with a directional component transverse to the top of the air curtain frame.

Thus the angle will vary if a force with a directional component parallel to the ceiling of the mounted air curtain is exerted, reducing the chance of damage to the air curtain. The base of the electrical fans is preferably at a horizontal distance of at least 1 cm from the longitudinally extending, downward facing air outlet.

FIG. 1 shows a trailer 100 with a cargo space 101 defined by a floor 102, a ceiling 103, and (four) side walls 104. One of the side walls (in this case as is usual the wall at the back of the vehicle) is provided with an access opening 105 that can be closed with a cargo door 106. As such, the vehicle is as common as it gets. However, the trailer 100 is provided with an air curtain 110. This air curtain 110 extends over the entire width of the cargo space 101 so as to provide an air-curtain over the width and height of the cargo space 101.

The ceiling 103 is an insulated ceiling 103 comprising polystyrene foam having a thickness of 10 cm. Part of this foam is removed to create an air curtain 110 comprising an inlet opening 211 facing the access opening 105, an air chamber 212 and an outlet opening 213 (the reference line of 213 ends at the distal end of the unit 320 discussed below). The outlet opening 213 comprises a multitude of parallel tubes (defining straight channels with a path length of 5 cm) 214, the centerlines of said tubes 214 being perpendicular to the floor 102. A row of computer fans 215 extending over the length of the air curtain 110 (and hence over the width of the cargo space 101) draw in ambient air via the inlet opening 211, introducing it into the air chamber 212 from which it flows through the parallel tubes 214 out of the outlet opening 213, creating in effect a vertical air-curtain.

In accordance with a preferred embodiment of the invention, the volume of the air chamber is increased by the distance d from a back wall 204 of the air curtain 110 being spaced horizontally by at least 2 cm from the outlet opening 213.

The parallel tubes 214 are part of a unit 320 that in use (and as shown in FIG. 2) is seated in an opening 321 of the bottom 322 of the air curtain 110. The unit 320 has two beveled sides 323, 324, that allow the unit 320 to be taken up inside the air chamber 212 if a force (arrow F) is exerted inadvertently on the unit 320, e.g. if a pallet loaded with parcels is moved out of the cargo space 101. FIG. 3 shows the unit 320 while unseated. It will return to its proper position for generating an air-curtain once the pallet is removed from the cargo space. This set-up also allows the cargo space 101 to be filled with cargo against the ceiling 103, without the air curtain being in the way.

In the embodiment shown, the unit 320 has flanges 325 that in the seated position will rest on the bottom 322 of the air curtain. To avoid noise from the unit 320 due to vibrations of the trailer 100 while moving, rubber pads 326 may be provided which should provide a seal so as to avoid air from leaking out of the air chamber 212. Also, magnets 327 may be used to keep the unit 320 seated. This embodiment allows for easy inspection of the fans 215, as the unit 320 may be tilted on purpose as shown in FIG. 3.

The beveled sides 323, 324 do not necessarily have to be in contact with the walls defining the air outlet at the distal end of the unit 320, so here they do not have to be in contact with the parallel tubes 214. This provides further protection against damage, because deformation of the parallel tubes 214 could reduce the proper generation of an air-curtain.

It goes without saying that the above embodiment is non-limiting and that the appending claims allow a large variety of embodiments. By way of example, the air chamber may be defined by a tube of flexible material (e.g. rubber of plastic), the flexible material providing the degree of freedom required for the longitudinally extending outlet opening to move. Such a flexible tube allows for easy mounting, e.g in case insulating foam removed from a ceiling of a truck retro-fitted with an air curtain is irregular. The fans will inflate the tube, maximizing the volume of the air chamber. The door of the vehicle fitted with an air curtain according to the invention may be a rolling door, that in an open position allows for the unit to protrude from the ceiling, whereas in a closed position or during closing may push the unit into the air curtain.

In some aspects, the invention can be further characterized as follows:

a. A method of providing a vehicle (100) for transporting freight that has to be kept at a temperature different from the ambient temperature of the vehicle (100) with an air curtain (110), the vehicle (100) comprising a closed cargo space (101) defined by a floor (102), a ceiling (103), and upright walls (104), an upright wall of said upright walls (104) having an access opening (215) that can be closed with a cargo door (106), the method comprising the step of providing the vehicle at the ceiling (103) with the air curtain (110), said provided air curtain (110) having
a longitudinally extending air inlet opening (211);
a longitudinally extending, downward facing air outlet (213);
an air chamber (212) downstream of the longitudinally extending air inlet opening (211) and upstream of the longitudinally extending, downward facing air outlet (213), characterized in that the vehicle (100) is provided with an air curtain (110) such that the air curtain (110) comprises a unit (320) containing the longitudinally extending air outlet (213), the unit having a distal end, wherein the unit is mounted such that the distal end of the unit (320) is moveable with a directional component transverse to the ceiling (103).

b. The method according to clause a, wherein a longitudinally extending side of the unit (320) is beveled so as to allow the distal end of the unit (320) to move towards the ceiling (103) if a force with a directional component parallel to the ceiling (103) is exerted on said beveled, longitudinally extending side of the unit (320).

c. The method according to clause a or b, wherein the unit (320) of the air curtain (110) that is provided has a longitudinally extending side (323, 324) at an inclined, non-perpendicular angle with the floor (102) at at least one longitudinal side of i) the side facing the access opening (215), and ii) the side facing away from the access opening (215).

d. The method according to any of the preceding clauses, wherein the ceiling (103) of the vehicle (100) is an insulated ceiling (103) having an upper surface and a lower surface, and the air chamber (212) is provided at least partially above the lower surface of the insulated ceiling (103).

e. The method according to any of the preceding clauses, wherein a row of electrical fans (215) between the longitudinally extending air outlet (213) and the longitudinally extending air inlet opening (211) is provided for introducing air into the air curtain (110) and expelling it through the longitudinally extending, downward facing air outlet (213) for generating an air-curtain.

f. The method according to any of the preceding clauses, wherein the vehicle (100) is provided with an air curtain (110) such that the air chamber (212) comprises a back wall (204) opposite of the longitudinally extending air inlet opening (211), said back wall (204) being at a horizontal distance of at least 2 cm from the longitudinally extending, downward facing air outlet (213).

g. The method according to any of the preceding clauses, wherein the air outlet (213) of unit (320) comprises a plurality of tubular through channels.

h. An air curtain (110) comprising a longitudinally extending frame comprising
a longitudinally extending air inlet opening (211); and
a longitudinally extending air outlet (213), characterized in that the air curtain (110) comprises a unit (320) containing the longitudinally extending air outlet (213), the unit (320) having a distal end that is moveable with respect to the air curtain frame in a plane perpendicular to the longitudinal direction of the longitudinally extending frame.

i. The air curtain according to clause h, wherein the air curtain (110) comprises a unit (320) containing the longitudinally extending air outlet (213), the unit (320) having a distal end that is moveable with respect to the air curtain (110) with a directional component parallel to a flow path defined by the longitudinally extending air outlet (213) at the distal end thereof.

j. The air curtain according to clause h or i, wherein the air curtain (110) has a bottom and the distal end of the unit (320) is capable of partially protruding from said bottom (322).

k. The air curtain according to any of the clauses h to j, wherein a longitudinally extending side of the unit (320) is beveled so as to allow the distal end of the unit (320) to move towards the frame of the air curtain (110) if a force perpendicular to the flow path of the longitudinally extending air outlet (213) at the distal end of the unit (320) is exerted on said longitudinally extending side of the unit (320).

l. The air curtain according to any of the clauses h to k, wherein a longitudinally extending side (323, 324) of the unit (320) is at an angle β to the direction of the flow path for air defined by the longitudinally extending air outlet (213) at the distal end of the unit (320), the angle β being in a plane perpendicular to the longitudinal direction of the longitudinally extending air outlet (213), the angle β being between 20 and 80°.

m. The air curtain according to any of the clauses h to l, wherein there is a row of electrical fans (215) between the longitudinally extending air outlet (213) and the longitudinally extending air inlet opening (211) for introducing air into the air curtain (110) and expelling it through the longitudinally extending, downward facing air outlet (213) for generating an air-curtain.

n. The air curtain according to any of the clauses h to m, wherein the electrical fans (215) are mounted tiltable able with a directional component transverse to the top of the air curtain (110) frame.

1. An air curtain comprising a longitudinally extending frame comprising
a longitudinally extending air inlet opening; and
a longitudinally extending air outlet, characterized in that there is a row of electrical fans between the longitudinally extending air outlet and the longitudinally extending air inlet opening for introducing air into the air curtain and expelling it through the longitudinally extending air outlet for generating an air-curtain.

2. The air curtain according to claim 1, wherein there are at least 6 electrical fans per meter of the longitudinally extending air outlet and preferably at least 8.

3. The air curtain according to claim 2, wherein the electrical fans have a spacing of less than 5 cm, preferably less than 3 cm between each other, and more preferably less than 1 cm.

4. The air curtain according to claim 1, wherein the plane of rotation of the electrical fans is at an angle to the direction of the flow path defined by the air outlet.

5. The air curtain according to claim 1, wherein an air diffuser is provided between the electrical fans and the longitudinally extending air outlet.

6. The air curtain according to claim 5, wherein downstream of an electrical fan there is an air diffuser having i) an central inlet opening downstream of the center of the electrical fan and ii) a central outlet opening, the ratio of the surface area of the central inlet opening to the surface area of the central outlet opening >1.1, defining a convergent flow path, and a second flow path downstream of the electrical fan bypassing said convergent flow path and merging with the convergent flow path before the longitudinally extending air outlet.

7. The air curtain according to claim 1, wherein the air curtain comprises curved baffles for guiding air from a first direction determined by at least one of the electrical fan and a housing of the air curtain to a second direction defined by at least one of the housing of the air curtain and the outlet opening of the air curtain.

8. Vehicle comprising an air curtain, characterized in that the air curtain is an air curtain as disclosed above.
